(19) United States
(12) Patent Application Publication
(10) Pub. No.: US 2022/0187889 A1
(43) Pub. Date: Jun. 16, 2022

(54) Power System Operational Support System and Power System Operational Support Method

(71) Applicant: Hitachi, Ltd., Chiyoda-ku, Tokyo (JP)

(72) Inventors: Kenta KIRIHARA, Tokyo (JP); Daichi KATO, Tokyo (JP); Takuya OKUYAMA, Tokyo (JP)

(21) Appl. No.: 17/439,648

(22) PCT Filed: Mar. 30, 2020
(86) PCT No.: PCT/JP2020/014677

§ 371 Date: Sep. 15, 2021

(30) Foreign Application Priority Data
Apr. 24, 2019 (JP) 2019-082782

(51) Int. Cl. G06F 1/26; G06N 10/20

(52) U.S. Cl. CPC G06F 1/26; G06N 10/20

(57) ABSTRACT

A power system can be controlled appropriately even when an amount of calculation increases. A system control signal determination problem data storage unit stores problem data indicative of a system control signal determination problem determining a plurality of control signals used for control of a device to be controlled included in the power system. A non-von Neumann calculation unit generates a non-von Neumann calculation result obtained by using a non-von Neumann computer to solve the system control signal determination problem on the basis of the problem data. An assessment criterion data storage unit stores assessment criterion data for assessing the non-von Neumann calculation result. A non-von Neumann calculation result assessment unit assesses an assessment item related to the non-von Neumann calculation result on the basis of the assessment criterion data.

### TECHNICAL FIELD

The present disclosure relates to a power system operational support system and a power system operational support method.

### BACKGROUND ART

In a power system field, the characteristics of facilities such as power supplies which make up a power system, and the trends in power consumers, etc. have changed significantly in recent years.

For example, a power source using renewable energy has become widespread along with a target for the reduction of global warming gases. Also, a complicated power consumption method using a power control function has become widespread with higher performance of an apparatus which becomes a load on power. Further, electricity trading between power consumers is becoming possible. Along with such changes, the amount of calculation for stabilizing the power system is increasing, and hence the stable operation of the power system may become difficult when this trend continues even in the future.

A technique for stabilizing the power system has been disclosed in each of Patent Literatures 1 to 3.

In the technique described in Patent Literature 1, a calculation for stabilizing the power system is distributed to a plurality of devices. Further, in the technique described in each of Patent Literatures 2 and 3, a calculation for controlling the power system is simplified by reducing a power system model showing the power system.

### CITATION LIST

### Patent Literature

PTL 1: Japanese Patent Application Laid-Open No. 2015-130727

PTL 2: Japanese Patent Application Laid-Open No. 2018-57118

PTL 3: Japanese Patent Application Laid-Open No. 2018-157673

### SUMMARY OF INVENTION

### Technical Problem

In the technique described in Patent Literature 1, since the calculation for stabilizing the power system is distributed to the plurality of devices, it is possible to suppress the amount of calculation in each individual device. However, in the future, if the control on the power system becomes more complicated due to an increase in the number of targets to be controlled or the like, the processing of distributing the calculation becomes complicated, and there is a risk that the power system cannot be appropriately controlled.

Further, in the techniques described in Patent Literatures 2 and 3, since the calculation is simplified by reducing the power system model, it is possible to suppress an increase in the amount of calculation. There is however a risk that when the calculation is simplified, the accuracy of the power system model may be reduced, and the power system may not be controlled properly.

The present disclosure has been made in view of the above problems, and an object thereof is to provide a power system operational support system and a power system operational support method capable of appropriately controlling a power system even when the amount of calculation increases.

### Solution to Problem

A power system operational support system according to one aspect of the present disclosure includes a problem storage unit which stores problem data indicative of a determination problem determining a plurality of control signals used for control of a controlled device included in a power system, a non-von Neumann calculation unit which generates a non-von Neumann calculation result obtained by using a non-von Neumann computer to solve the determination problem on the basis of the problem data, a criterion storage unit which stores assessment criterion data for assessing the non-von Neumann calculation result, and an assessment unit which assesses an assessment item related to the non-von Neumann calculation result on the basis of the assessment criterion data.

### Advantageous Effects of Invention

According to the present invention, it is possible to appropriately control a power system even when the amount of calculation increases.

### BRIEF DESCRIPTION OF DRAWINGS

FIG. 1 is a diagram showing an example of a functional configuration of a power system operational support system according to a first embodiment of the present disclosure.

FIG. 2 is a diagram showing a hardware configuration of the power system operational support system and a configuration of a power system.

FIG. 3 is a diagram schematically showing an example of the power system.

FIG. 4 is a diagram for describing a system control signal determination problem for maintaining a balance between demand and supply of the power system.

FIG. 5 is a flowchart for describing an example of the operation of the power system operational support system.

FIG. 6 is a flowchart for describing an example of non-von Neumann calculation processing.

FIG. 7 is a sequence chart for describing an example of non-von Neumann calculation processing.

FIG. 8 is a flowchart for describing an example of non-von Neumann calculation result assessment processing.

FIG. 9 is a diagram showing an output example of an assessment result and a non-von Neumann calculation result.

FIG. 10 is a diagram showing another output example of an assessment result and a non-von Neumann calculation result.

FIG. 11 is a diagram showing an example of a functional configuration of a power system operational support system according to a second embodiment of the present disclosure.

FIG. 12 is a flowchart for describing an example of the operation of an assessment result feedback unit.

FIG. 13 is a diagram showing an example of a functional configuration of a power system operational support system according to a third embodiment of the present disclosure.

FIG. 14 is a flowchart for describing an example of the operation of a control unit.

FIG. 15 is a diagram showing an example of an Ising model.

FIG. 16 is a flowchart for describing an example of the operation of a non-von Neumann calculation unit in a fourth embodiment.

FIG. 17 is a diagram showing an example of discretized output power of a generator.

FIG. 18 is a diagram showing an example of a correspondence relationship between a spin and an external magnetic field.

FIG. 19 is a diagram showing an example of a functional configuration of a power system operational support system according to a fifth embodiment.

FIG. 20 is a flowchart for describing an example of the operation of an assessment criterion creating unit.

### DESCRIPTION OF EMBODIMENTS

Hereinafter, embodiments of the present disclosure will be described with reference to the drawings.

### First Embodiment

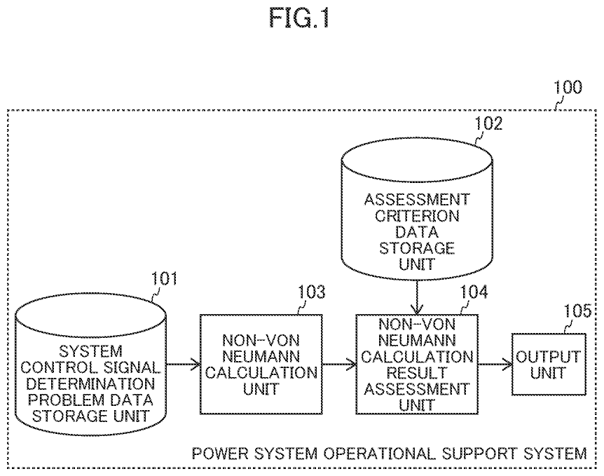

FIG. 1 is a diagram showing an example of a functional configuration of a power system operational support system according to the first embodiment of the present disclosure. The power system operational support system 100 shown in FIG. 1 is a system for supporting the operation of a power system and includes a system control signal determination problem data storage unit 101, an assessment criterion data storage unit 102, a non-von Neumann calculation unit 103, a non-von Neumann calculation result assessment unit 104, and an output unit 105.

The system control signal determination problem data storage unit 101 (hereinafter abbreviated as problem data storage unit 101) is a storage unit which stores therein system control signal determination problem data (hereinafter abbreviated as problem data) indicative of a system control signal determination problem being a determination problem which determines a plurality of control signals used for control of a controlled devices included in the power system. The problem data includes constraint data indicating the constraints that the power system follows, target data indicating the purpose of using the control signal, a time interval for switching the control signals, and the like. The problem data includes time intervals to resolve problems, etc. The constraint data is power flow constraints of the power system, a power suppliable amount of each power source in the power system, a warming gas emission amount in the power system, a power demand amount, etc. The target data is indicative of, for example, maintaining the balance between demand and supply of the power system, maintaining the voltages at multiple locations, increasing the amount of power generated by renewable energy, and stabilizing the system at the occurrence of disturbances at an early stage to avoid a decrease in efficiency due to a partial power outage, etc.

The assessment criterion data storage unit 102 is a criterion storage unit which stores assessment criterion data for assessing a non-von Neumann calculation result which is a calculation result of the non-von Neumann calculation unit 103 to be described later. The non-von Neumann calculation result is a result obtained by solving the system control signal determination problem shown by the problem data through the use of a non-von Neumann computer to be described later, and shows a plurality of control values which are the values of the determined multiple control signals.

The assessment criterion data specifically shows a criterion value for each assessment item related to the non-von Neumann calculation result. In the present embodiment, the assessment item includes each control value indicated by the non-von Neumann calculation result, an interrelation value indicating the interrelationship of each control value, and a calculation time taken until the non-von Neumann computer solves the system control signal determination problem. In the present embodiment, the interrelation value is the total value of each control value, but other values may be used. Incidentally, the assessment item may be at least one of a control value, an interrelation value, and a calculation time, or other information may be used. The criterion value includes, for example, upper and lower limit values (upper limit value and lower limit value) of each control value, a mutual criterion value regarding the interrelation value (in the present embodiment, a total upper limit value which is an upper limit value of the total value of each control value), and a time lower limit value which is a lower limit value of the calculation time.

The non-von Neumann calculation unit 103 performs non-von Neumann calculation processing which is calculation processing using the non-von Neumann computer. In the present embodiment, the non-von Neumann calculation unit 103 solves, using the non-von computer, the system control signal determination problem indicated by the problem data, based on the problem data stored in the problem data storage unit 101 as the non-von Neumann calculation processing to determine a plurality of control signals, and perform problem solving processing to generate a non-von Neumann calculation result indicating those control signals. In the problem solving processing, at least one solution of the system control signal determination problem may be calculated.

The non-von Neumann calculation result assessment unit 104 assesses the assessment item related to the non-von Neumann calculation result which is the calculation result by the non-von Neumann calculation unit 103, based on the assessment criterion data stored in the assessment criterion data storage unit 102 and outputs the assessment result.

The output unit 105 outputs the assessment result from the non-von Neumann calculation result assessment unit 104. The output unit 105 may display the assessment result, for example, or may output it in another format. Further, the output by the output unit 105 also includes outputting to another device. In addition, the output unit 105 may output the non-von Neumann calculation result of the non-von Neumann calculation unit 103, the problem data stored in the problem data storage unit 101, the assessment criterion data stored in the assessment criterion data storage unit 102, and the like.

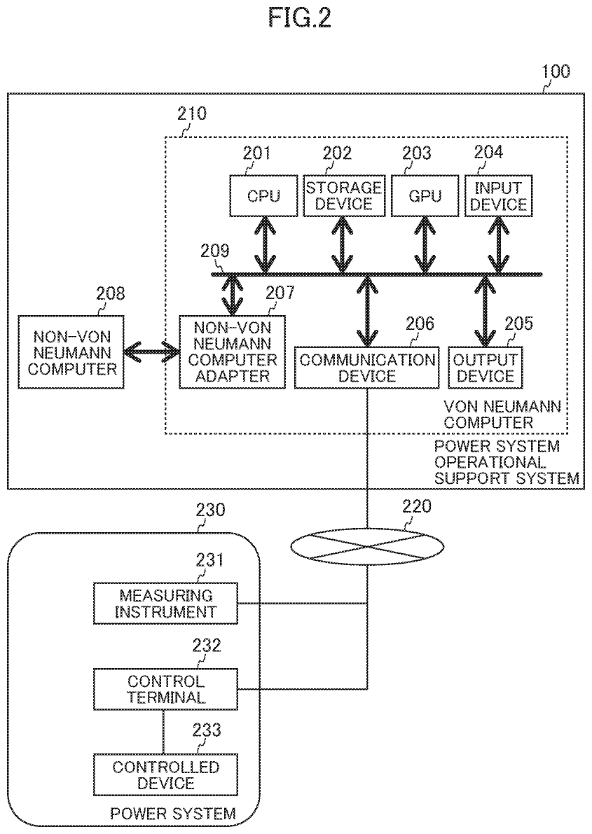

FIG. 2 is a diagram showing a hardware configuration of the power system operational support system and a configuration of the power system.

As shown in FIG. 2, the power system operational support system 100 includes a CPU (Central Processing Unit) 201, a storage device 202, a GPU (Graphics Processing Unit) 203, an input device 204, an output device 205, a communication device 206, a non-von Neumann computer adapter 207, and a non-von Neumann computer 208 as components. The components 201 to 207 are connected to each other via a data bus 209. The respective components 201 to 207 connected to the data bus 209 constitute a von Neumann computer 210. The non-von Neumann computer 208 is interconnected with the non-von Neumann computer adapter 207 of the von Neumann computer 210.

The problem data storage unit 101, the assessment criterion data storage unit 102, the non-von Neumann calculation result assessment unit 104, and the output unit 105 shown in FIG. 1 are realized by the von Neumann computer 210. The non-von Neumann calculation unit 103 is realized by the non-von Neumann computer adapter 207 and the non-von Neumann computer 208.

The CPU 201 reads a program stored in the storage device 202 to be described later and executes the read program to perform various calculation processing. The CPU 201 may be comprised of one semiconductor chip or may be comprised of a plurality of semiconductor chips. Further, the CPU 201 may be replaced by another processor, or may be replaced by an external computer like a calculation server.

The storage device 202 has at least one of a RAM (Random Access Memory), a ROM (Read Only Memory), and an HDD (Hard Disk Drive), or the like and stores therein programs and data required for each calculation processing performed by the power system operational support system 100. The data stored in the storage device 202 includes, for example, image data for display, calculation result data of each calculation processing, usage data used in each calculation processing, and calculation temporary data generated in the middle of each calculation processing, etc.

The GPU 203 is a processor for displaying the calculation result of the calculation processing by the CPU 201 on a display (for example, the output device 205). For example, the CPU 201 generates image data, and the GPU 203 displays the image data on the output device 205.

Incidentally, the GPU 203 may be used for calculation processing in the same manner as the CPU 201, and a part or all of the function of the GPU 203 may be realized by the CPU 201.

The input device 204 receives various instructions and information from a user who uses the power system operational support system 100. The user is, for example, a system operator or the like in a control center for controlling the power system 230. Further, the user is not limited to a human being, and may be, for example, a robot or the like. The input device 204 is not particularly limited as long as it is capable of receiving instructions and information therein, but has, for example, at least one of a keyboard switch, a pointing device such as a mouse, a touch panel, a line-of-sight estimation device using a camera or the like, a brain wave converter, and a voice instruction device, and the like.

The output device 205 presents various information to the user by outputting them. The output device 205 is not particularly limited as long as it can present information to the user, but includes, for example, at least one of a display, a printer device, an audio output device, a vibration generator, and a light source such as a lamp. Further, the output device 205 may be a communication device or the like which transmits information to a portable terminal, a wearable terminal, or the like.

The communication device 206 is provided with a circuit or the like for connecting to a communication network 220 and is communicably connected to the power system 230 via the communication network 220. Incidentally, the communication device 206 may be used as the output device 205.

The non-von Neumann computer adapter 207 is a conversion unit which converts data or the like corresponding to the von Neumann computer 210 into a format corresponding to the non-von Neumann computer 208 and inputs the data to the non-von Neumann computer 208. In the present embodiment, the non-von Neumann computer adapter 207 converts the problem data into a format corresponding to the non-von Neumann computer 208 and inputs it to the non-von Neumann computer 208. Further, the non-von Neumann computer adapter 207 acquires a non-von Neumann calculation result from the non-von Neumann computer 208, converts the non-von Neumann calculation result into a format which can be processed by the von Neumann computer 210, and outputs the same.

The non-von Neumann computer 208 is a computer which operates in a principle of operation different from that of the von Neumann computer 210, and can execute specific processing like the above problem-solving processing at a higher speed than by the von Neumann computer 210. The non-von Neumann computer 208 includes, for example, a quantum computing machine (quantum computer), a nerve cell computer (neurocomputer), etc. The non-von Neumann computer 208 performs calculation processing in response to an instruction from the von Neumann computer 210.

The power system 230 has a measuring instrument 231, a control terminal 232, and a controlled device 233. There may be a plurality of measuring instruments 231, control terminals 232 and controlled devices 233, respectively.

The measuring instrument 231 measures measurement targets (not shown) arranged in various locations in the power system 230 and transmits their measurement results to the communication device 206 of the power system operational support system 100 via the communication network 220. The measuring instrument 231 includes, for example, devices or the like arranged in the power system 230, such as power management units (PMU: Phasor Measurement Units), a transformer (VT: Voltage Transformer), a power transformer (PT: Power Transformer), a current transformer (CT: Current Transformer), and a telemeter (TM: Telemeter), etc. Further, the measuring instrument 231 may be an aggregation device like SCADA (Supervisory Control and Data Acquisition) which aggregates the measured values measured by the power system 230.

The control terminal 232 controls the controlled device 233 arranged in each location in the power system 230. The control terminal 232 may control the controlled device 233 based on setting information set in advance, or may control the controlled device 233 based on a signal sent from the power system operational support system 100 via the communication network 220. The controlled device 233 is, for example, a generator, a distributed power source, a load, a measuring instrument, and the like. Incidentally, the control terminal 232 may control not only the power supply but also the demand by adjusting the power consumption by the load as well as the power source (generator and distributed power source, etc.).

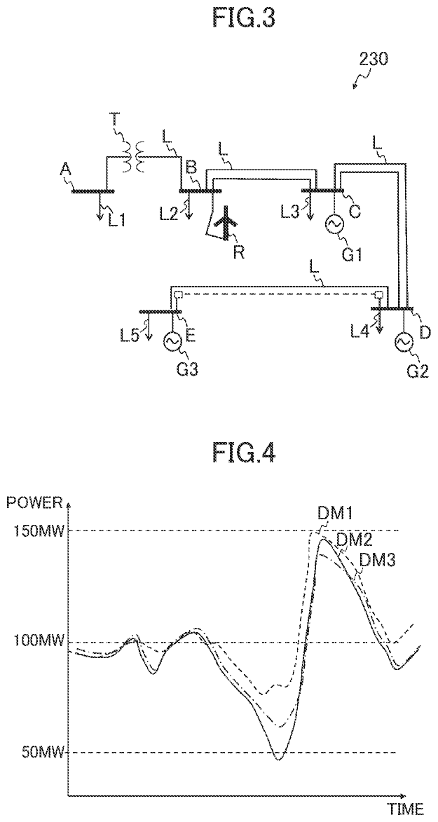

FIG. 3 is a diagram schematically showing an example of the power system 230. In the power system 230 shown in FIG. 3, five bus lines A to E are connected via a power transmission line L, and a transformer T is provided on the power transmission line L connecting the bus lines A and B. Also, loads L1 to L5 are connected to the buses A to E. Further, a distributed power source R is connected to the bus B, and generators G1 to G3 are connected to the buses C to E. In this case, for example, the generators G1 to G3 and the distributed power source R become the controlled device 233.

Further, the loads L1 to L5 and the transformer T may be adopted as the controlled device 233.

FIG. 4 is a diagram for describing a system control signal determination problem for maintaining a balance between the demand and supply of the power system 230 as an example of the system control signal determination problem, and shows an example of a time change in daily demand power in the power system 230.

As shown in FIG. 4, there are various patterns of the time change in the demand power as shown by demand curves DM1 to DM3 and the like. In order to maintain the balance between the demand and supply of the power system 230, it is necessary to control the power system 230 so that the amount of power generation and the amount of power demand match in any demand pattern.

When the number of controlled devices 233 such as a distributed power source R like a renewable energy power source increases in the power system 230, at least the following two problems may occur in maintaining the balance between the demand and supply. The first problem is that the influence of the renewable energy power source makes it difficult to determine one demand forecast. Therefore, it becomes necessary to consider a plurality of demand forecasts such as shown by the demand curves DM1 to DM3 shown in FIG. 4. Consequently, the amount of calculation may increase. The second problem is that as the number of controlled devices 233 increases, the number of control signals determined in the system control signal determination problem increases, so that the amount of calculation increases. In the present embodiment, the non-von Neumann computer 208 is used to cope with the increase in the amount of calculation.

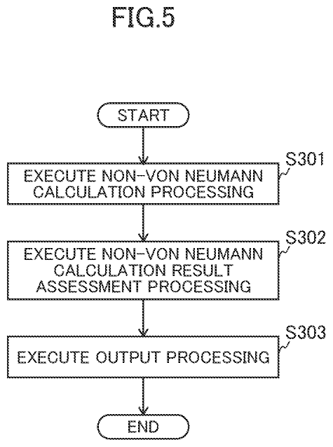

FIG. 5 is a flowchart for describing an example of the operation of the power system operational support system 100. The processing of the power system operational support system 100 described below may be executed, for example, at a time specified in advance, in a predetermined cycle, or according to a user's instruction. Alternatively, it may be executed by other triggers.

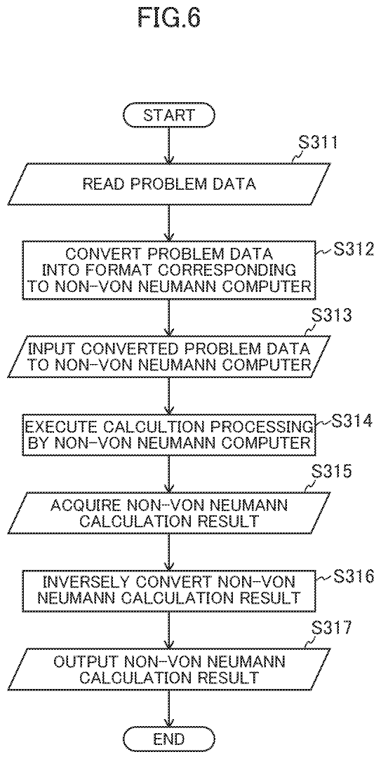

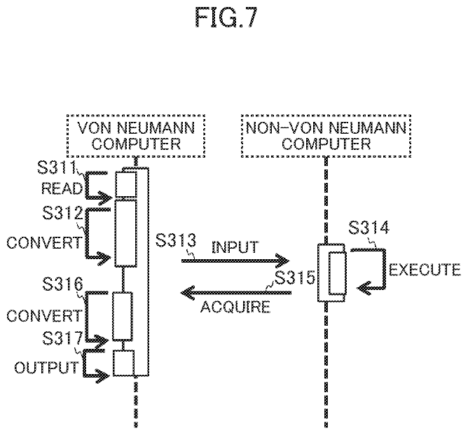

First, the non-von Neumann calculation unit 103 executes non-von Neumann calculation processing (refer to FIGS. 6 and 7) of outputting the non-von Neumann calculation result obtained by using the non-von Neumann computer 208 to solve the system control signal determination problem on the basis of the problem data stored in the problem data storage unit 101 (Step S301).

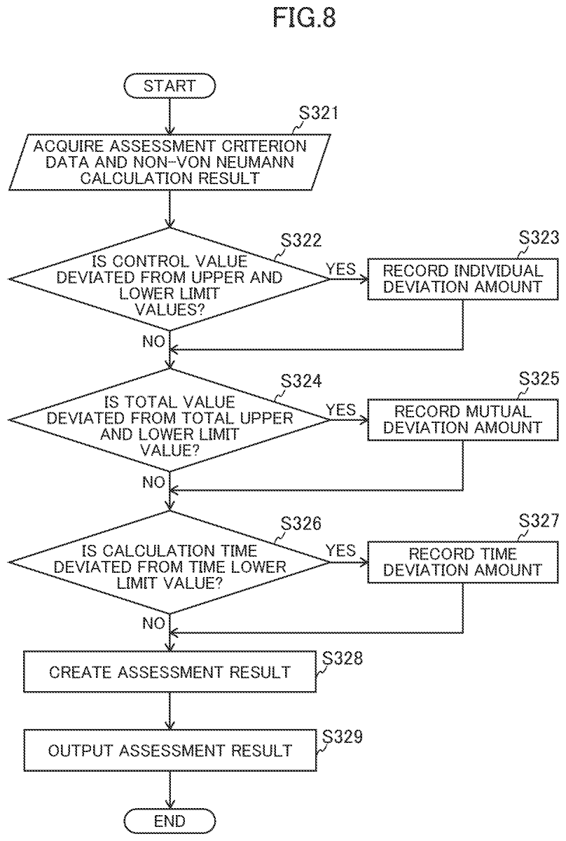

Subsequently, the non-von Neumann calculation result assessment unit 104 executes non-von Neumann calculation result assessment processing (refer to FIG. 8) of outputting an assessment result in which an assessment item related to the non-von Neumann calculation result from the non-von Neumann calculation unit 103 is assessed based on the assessment criterion data stored in the assessment criterion data storage unit 102 (Step S302).

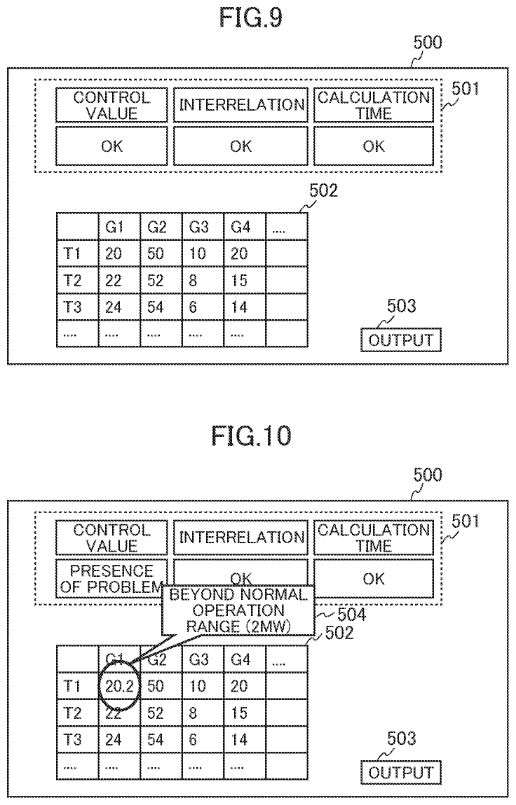

Then, the output unit 105 executes output processing (refer to FIGS. 9 and 10) of outputting the assessment result from the non-von Neumann calculation result assessment unit 104 from the output device 205 (Step S303).

FIGS. 6 and 7 are diagrams for describing an example of the non-von Neumann calculation processing. Specifically, FIG. 6 is a flowchart for describing an example of the non-von Neumann calculation processing, and FIG. 7 is a sequence chart for describing an example of the non-von Neumann calculation processing.

First, the non-von Neumann calculation unit 103 reads the problem data from the problem data storage unit 101 (Step S311). The non-von Neumann calculation unit 103 converts the problem data into a format corresponding to the non-von Neumann computer (Step S312). The non-von Neumann calculation unit 103 inputs the converted problem data to the non-von Neumann computer 208 (Step S313).

The non-von Neumann calculation unit 103 executes calculation processing of solving the system control signal determination problem indicated by the problem data by the non-von Neumann computer 208 and outputs its calculation result (Step S314).

The non-von Neumann calculation unit 103 acquires the calculation result from the non-von Neumann computer 208 as a non-von Neumann calculation result (Step S315). The non-von Neumann calculation unit 103 inversely converts the non-von Neumann calculation result into a format corresponding to the von Neumann computer 210 (Step S316). The non-von Neumann calculation unit 103 outputs the inversely converted non-von Neumann calculation result (Step S317).

As shown in FIG. 7, the von Neumann computer 210 executes the processing of Steps S311 to S313 and S315 to S317 described above, and the non-von Neumann computer 208 executes the processing of Step S314. Incidentally, a specific example of the non-von Neumann computer 208 will be described later in a fourth embodiment.

FIG. 8 is a flowchart for describing an example of the non-von Neumann calculation result assessment processing in Step S302 of FIG. 4.

First, the non-von Neumann calculation result assessment unit 104 acquires the non-von Neumann calculation result from the non-von Neumann calculation unit 103 and the assessment criterion data stored in the assessment criterion data storage unit 102 (Step S321). The non-von Neumann calculation result assessment unit 104 acquires each control value which is a first assessment item from the non-von Neumann calculation result, and confirms whether or not the control value deviates from the upper and lower limit values included in the assessment criterion data for each control value (Step S322). Specifically, the upper and lower limit values include an upper limit value and a lower limit value, and the non-von Neumann calculation result assessment unit 104 determines whether or not the control value is less than or equal to the upper limit value and greater than or equal to the lower limit value for each control value. When the control value is less than or equal to the upper limit value and greater than or equal to the lower limit value, the non-von Neumann calculation result assessment unit 104 determines that the control value does not deviate from the upper and lower limit values. When the control value exceeds the upper limit value, or when the control value is less than the lower limit value, the non-von Neumann calculation result assessment unit 104 determines that the control value deviates from the upper and lower limit values.

When the control value deviates from the upper and lower limit values, the non-von Neumann calculation result assessment unit 104 calculates and records an individual deviation amount in which the control value deviates from the upper and lower limit values for each control value deviating from the upper and lower limit values (Step S323). When the control value exceeds the upper limit value, the individual deviation amount is a value obtained by subtracting the upper limit value from the control value. When the control value is less than the lower limit value, the individual deviation amount is a value obtained by subtracting the control value from the lower limit value.

When the control value does not deviate from the upper and lower limit values and when the individual deviation amount is recorded, the non-von Neumann calculation result assessment unit 104 acquires the total value of each control value as the interrelation value being a second assessment item from the non-von Neumann calculation result and confirms whether or not the total value deviates from the total upper limit value included in the assessment criterion data (Step S324).

When the total value of each control value deviates from the total upper limit value, the non-von Neumann calculation result assessment unit 104 calculates and records a mutual deviation amount in which the total value of each control value deviates from the total upper limit value (Step S325). Specifically, the mutual deviation amount is a value obtained by subtracting the total upper limit value from the control value.

When the total value of each control value does not deviate from the total upper limit value and when the mutual deviation amount is recorded, the non-von Neumann calculation result assessment unit 104 acquires a calculation time of the non-von Neumann computer 208 as a third assessment item and confirms whether or not the calculation time deviates from the time lower limit value included in the assessment criterion data (Step S326).

When the calculation time deviates from the time lower limit value, the non-von Neumann calculation result assessment unit 104 calculates and records a time deviation amount in which the calculation time deviates from the time lower limit value (Step S327). Specifically, the time deviation amount is a value obtained by subtracting the calculation time from the time lower limit value.

The non-von Neumann calculation result assessment unit 104 creates an assessment result of the non-von Neumann calculation result (Step S328). Specifically, the non-von Neumann calculation result assessment unit 104 confirms whether or not the deviation amount (individual deviation amount, mutual deviation amount and time deviation amount) is recorded. When the deviation amount is recorded, the non-von Neumann calculation result assessment unit 104 creates as an assessment result, information indicating the deviation amount and a deviation item which is an assessment item corresponding to the deviation amount. When the deviation amount is not recorded, the non-von Neumann calculation result assessment unit 104 creates as an assessment result, information indicating that all the assessment items do not deviate from the criterion value.

The non-von Neumann calculation result assessment unit 104 outputs the created assessment result and the non-von Neumann calculation result (Step S331).

Since the assessment result of the non-von Neumann calculation result is output by the above processing, it is possible to present to the user, a material for determining whether or not to control the power system 230 using the non-von Neumann calculation result. At that time, since the assessment result includes the deviation amount, it is possible to present the non-von Neumann calculation result as a quantitative assessment. Incidentally, the non-von Neumann calculation result may be qualitatively assessed by recording a flag indicating that the assessment item deviates from the criterion value instead of the deviation amount.

FIGS. 9 and 10 are diagrams each showing an output example of the assessment result and the non-von Neumann calculation result by the output unit 105. In the examples of FIGS. 9 and 10, there are shown examples in which the output device 205 is used as a display, and the assessment result and the non-von Neumann calculation result are displayed on the output device 205. The output device 205 can provide a GUI (Graphical User Interface) for displaying problem data, assessment criterion data, a non-von Neumann calculation result, an assessment result, and the like.

In each of FIGS. 9 and 10, an output screen 500 displayed on the output device 205 is shown. The output screen 500 includes assessment information 501 showing an assessment result, a result table 502 showing a non-von Neumann calculation result, and an output button 503.

The assessment information 501 indicates whether or not the assessment item deviates from the criterion value for each assessment item. The assessment information 501 indicates that all the assessment items do not deviate from the criterion value in the example of FIG. 9. The assessment information 501 indicates that the control value deviates from the criterion value in the example of FIG. 10.

The result table 502 shows target output power [MW] for each control time (T1 to T3) with respect to each of the plural generators (G1, G2, G3, G4 . . . ). The control time is a time interval to switch the control signal, and is, for example, 1 hour or 5 minutes or the like. In the example of FIG. 10, the control value (target output power) corresponding to the generator G1 at the control time T1 deviates from the criterion value (20 MW). Its deviation amount (0.2 MW) is shown as notification information 504 in the output screen 500b.

The output button 503 is used to output the non-von Neumann calculation result to a predetermined device (for example, a control device that controls the power system 230). Further, the output screen 500 may include a cancel button or the like that does not perform the output of the non-von Neumann calculation result to the predetermined device.

As shown in FIGS. 9 and 10, the user can determine whether or not the assessment item deviates from the criterion value. In the present embodiment, even if the assessment item deviates from the criterion value, it is up to the user whether or not to allow it. For example, in principle, in order to hold the balance between the demand and supply of the power system, it is desirable that the control value does not deviate from the upper and lower limit values, but in practical use, there is no problem even if the control value deviates slightly from the upper and lower limit values. Therefore, at the user's discretion, when the individual deviation amount is small, the power system 230 may be controlled using the non-von Neumann calculation result. Similarly, there is no problem even if the total value of each control value deviates slightly from the total upper limit value.

Further, the calculation time of the non-von Neumann computer 208 may be considerably shorter than the calculation time of the von Neumann computer, but for users who are accustomed to the von Neumann computer, when the calculation time is too short, there is a risk of anxiety about whether or not the calculation is performed properly. Therefore, it is possible to give the user a sense of security by assessing the calculation time. Further, when the calculation time of the non-von Neumann computer 208 is too short, there is also a risk that the calculation will not be actually performed properly.

### Second Embodiment

In the present embodiment, as an application example of the first embodiment, description will be made about an example in which the assessment result by the non-von Neumann calculation result assessment unit 104 is fed back to the non-von Neumann calculation unit 103. Hereinafter, the points of difference from the first embodiment will be mainly described.

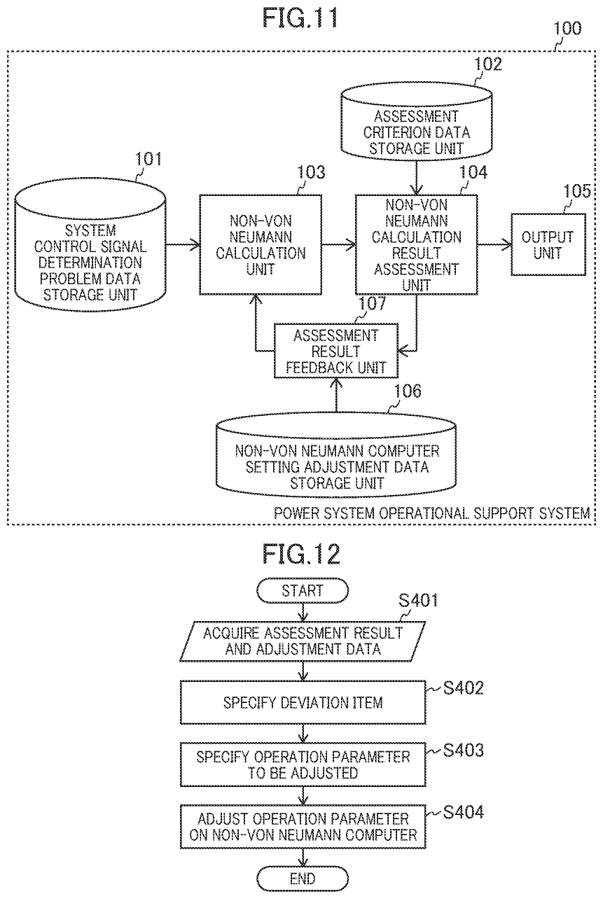

FIG. 11 is a diagram showing an example of a functional configuration of a power system operational support system of the second embodiment. The power system operational support system 100 shown in FIG. 11 has a non-von Neumann computer setting adjustment data storage unit 106 and an assessment result feedback unit 107 in addition to the configuration of the power system operational support system 100 shown in FIG. 1.

The non-von Neumann computer setting adjustment data storage unit (hereinafter abbreviated as adjustment data storage unit) 106 stores therein non-von Neumann computer setting adjustment data (hereinafter abbreviated as adjustment data) for adjusting operation parameters being parameters of non-von Neumann calculation processing which solves the system control signal determination problem by the non-von Neumann calculation unit 103 (more specifically, the non-von Neumann computer 208). The operation parameters are parameters which affect non-von Neumann calculation processing results. For example, in the case of an Ising model of a fourth embodiment to be described later, the operation parameters are an external magnetic field, a mutual magnetic field (penalty terms γ₁ and γ₂, etc.), and a calculation time, etc. The adjustment data shows, for example, the relationship between the assessment result and the operation parameter. More specifically, the adjustment data shows the relationship between the deviation item being the assessment item deviating from the criterion value, and the operation parameter to be adjusted. For example, there is mentioned a case where the calculation time is short.

The assessment result feedback unit 107 adjusts the operation parameters of the non-von Neumann computer 208 based on the assessment result by the non-von Neumann calculation result assessment unit 104 and the adjustment data stored in the adjustment data storage unit 106.

For example, when the calculation time deviates from the criterion value (calculation lower limit value) in the assessment result, the assessment result feedback unit 107 lengthens the calculation time by adjusting a specific operation parameter of the non-von Neumann computer 208. Further, when the control value or the interrelation value deviates from the criterion value, the assessment result feedback unit 107 adjusts the operation parameter related to the constraint condition in the non-von Neumann calculation processing so that the constraint condition becomes stronger.

FIG. 12 is a flowchart for describing an example of the operation of the assessment result feedback unit 107.

First, the assessment result feedback unit 107 acquires an assessment result from the non-von Neumann calculation result assessment unit 104 and acquires adjustment data from the adjustment data storage unit 106 (Step S401).

The assessment result feedback unit 107 specifies a deviation item being an assessment item which deviates from the criterion value, based on the assessment result (Step S402). The assessment result feedback unit 107 specifies an operation parameter to be adjusted, based on the deviation item and the adjustment data (Step S403). The assessment result feedback unit 107 performs adjustment processing of adjusting the specified operation parameter on the non-von Neumann calculation unit 103 (Step S404).

### Third Embodiment

In the present embodiment, as an application example of the second embodiment, description will be made about an example in which the von Neumann calculation result by the von Neumann computer is further used. Hereinafter, the points of difference from the second embodiment will be mainly described.

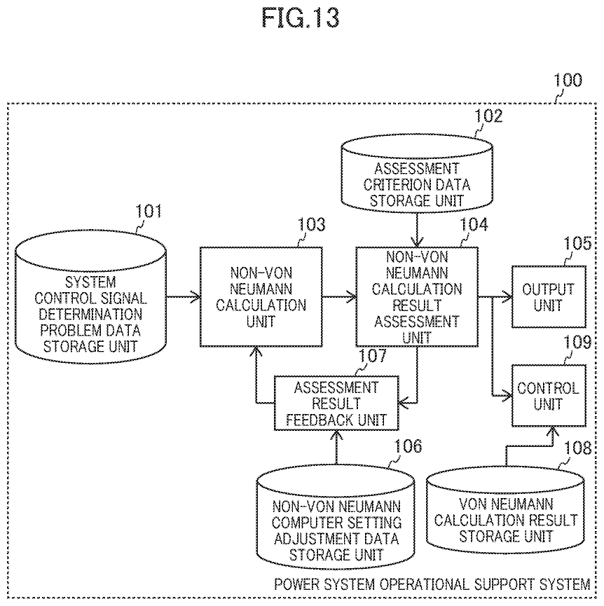

FIG. 13 is a diagram showing an example of a functional configuration of a power system operational support system according to the third embodiment. The power system operational support system 100 shown in FIG. 13 has a von Neumann calculation result storage unit 108 and a control unit 109 in addition to the configuration of the power system operational support system 100 shown in FIG. 11.

The von Neumann calculation result storage unit 108 stores therein the von Neumann calculation result in which the system control signal determination problem indicated by the problem data stored in the problem data storage unit 101 is solved by using the von Neumann computer. The von Neumann computer which calculates the von Neumann calculation result may be the von Neumann computer 210 shown in FIG. 2 or another computer. Further, the von Neumann calculation result may be a calculation result that simplifies the system control signal determination problem and thereby solves it.

For example, using an approximation method that approximates a high-dimensional determination problem to a low-dimensional determination problem, the system control signal determination problem is approximated to a low-dimensional problem, and a calculation result obtained by solving the approximated system control signal determination problem may be taken as a von Neumann calculation result.

The control unit 109 controls the controlled device 233 by using either the non-von Neumann calculation result or the von Neumann calculation result stored in the von Neumann calculation result storage unit 108, based on the assessment result by the non-von Neumann calculation result assessment unit 104. For example, the control unit 109 controls the controlled device 233 by using the non-von Neumann calculation result when the assessment result satisfies a predetermined condition, and controls the controlled device 233 by using the von Neumann calculation result when the assessment result does not satisfy the predetermined condition. The predetermined condition is, for example, that all the assessment items do not deviate from the criterion value, etc.

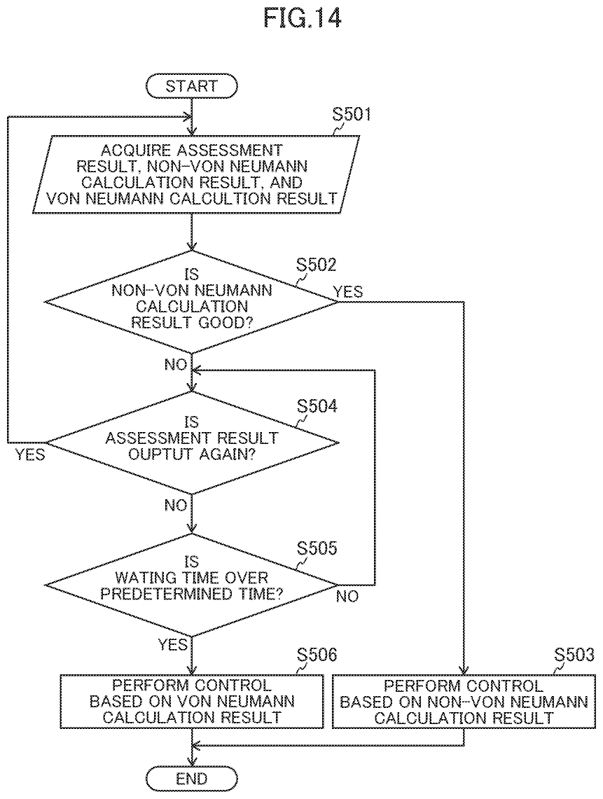

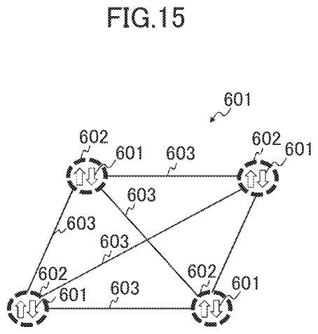

FIG. 14 is a flowchart for describing an example of the operation of the control unit 109.

First, the control unit 109 acquires an assessment result and a non-von Neumann calculation result from the non-von Neumann calculation result assessment unit 104, and acquires a von Neumann calculation result from the von Neumann calculation result storage unit 108 (Step S501). The control unit 109 determines based on the assessment result whether or not there is an assessment item that deviates from the criterion value, and determines whether or not the non-von Neumann calculation result is good (Step S502). The control unit 109 determines that the non-von Neumann calculation result is good when there is no assessment item deviating from the criterion value, and determines that the non-von Neumann calculation result is not good when there is an assessment item deviating from the criterion value.

When the non-von Neumann calculation result is good, the control unit 109 controls the controlled device 233 in the power system 230 based on the non-von Neumann calculation result (Step S503). For example, the control unit 109 outputs a control signal corresponding to the non-von Neumann calculation result to the controlled device 233 via the control terminal 232 in the power system 230 to control the controlled device 233.

On the other hand, when the non-von Neumann calculation result is not good, the feedback processing such as described in FIG. 12 is performed, and the non-von Neumann calculation processing is performed again. The control unit 109 confirms whether or not the assessment result is output again (Step S504). When the assessment result is output again, the control unit 109 returns to the processing of Step S501. When the assessment result is not output again, the control unit 109 first confirms whether or not a waiting time after determining that the non-von Neumann calculation result is not good exceeds a predetermined time (Step S505).

When the waiting time does not exceed the predetermined time, the control unit 109 returns to the processing of Step S504. On the other hand, when the waiting time exceeds the predetermined time, the control unit 109 controls the controlled device 233 in the power system 230 based on the von Neumann calculation result (Step S506). For example, the control unit 109 outputs a control signal corresponding to the von Neumann calculation result to the controlled device 233 in the power system 230 to control the controlled device 233.

### Fourth Embodiment

In the present embodiment, description will be made about an example in which a quantum computer using an Ising model is applied as the non-von Neumann computer 208.

FIG. 15 is a diagram showing an example of the Ising model. As shown in FIG. 15, the Ising model 600 is a model having one or more spins 601, an external magnetic field 602 acting on each spin 601, and a mutual magnetic field 603 which is an interaction between the spins 601. The figure shows an example in which the number of spins 601 is four.

The spin 601 is a binary variable which takes one of values “1” and “0”. The external magnetic field 602 and the mutual magnetic field 603 take discrete values.

The quantum computer using the Ising model determines the spin 601 so that the Hamiltonian (energy function) H (σ) represented by an equation (1) becomes small, for example.

H(σ)=−Σ_{i<j}Jᵢⱼσᵢσⱼ−Σᵢ₌₁^{N} hᵢσᵢ (1)

In the equation (1), the first term on the left side is called an interaction term, and the second term is called an objective function. Further, σᵢ denotes the spin 601, hᵢ denotes the external magnetic field 602, and Jᵢⱼ denotes the mutual magnetic field 603. Incidentally, the code before each term may be positive.

The non-von Neumann calculation unit 103 converts the problem data stored in the problem data storage unit 101 into problem data indicating a combination problem in which the value of the spin 601 is determined so that the Hamiltonian H(σ) becomes small, and executes non-von Neumann calculation processing.

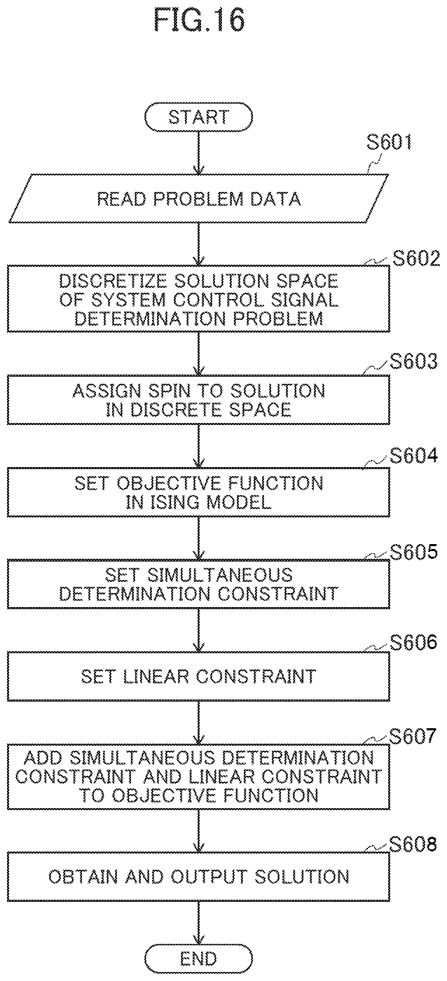

FIG. 16 is a flowchart for describing an example of the operation of the non-von Neumann calculation unit 103 in the present embodiment.

First, the non-von Neumann calculation unit 103 reads the problem data from the problem data storage unit 101 (Step S601). Then, the non-von Neumann calculation unit 103 discretizes a solution space of a system control signal determination problem indicated by the problem data (Step S602). The non-von Neumann calculation unit 103 performs mapping processing of assigning each solution in the discrete solution space being the discretized solution space to the spins (Step S603).

The non-von Neumann calculation unit 103 sets the objective function of the Ising model on the basis of the processing result of the mapping processing and the problem data (Step S604). The non-von Neumann calculation unit 103 sets a simultaneous determination constraint for each solution (Step S605). The non-von Neumann calculation unit 103 sets a linear constraint for each solution (Step S606). The simultaneous determination constraint is a first constraint condition for determining a single solution for each control signal. The linear constraint is a second constraint condition related to the interrelation of each control signal. The simultaneous determination constraint and the linear constraint correspond to the interaction term of the equation (1). The linear constraint is represented using auxiliary spins to which each solution in the discrete solution space is not assigned.

The non-von Neumann calculation unit 103 constructs the Hamiltonian by adding together the objective function, the simultaneous determination constraint, and the linear constraint (Step S607). The non-von Neumann calculation unit 103 generates and outputs a non-von Neumann calculation result having solved the combination problem by using the Hamiltonian (Step S608).

Hereinafter, the above operation will be specifically described by taking as an example, the problem of improving the efficiency of power supply while maintaining the demand and supply balance of the power system 230. Further, the power system 230 includes N generators G₁ to G_{N} as power sources. In addition, the generators G₁ to G_{N} are taken as controlled devices.

In the above-mentioned problem of improving the efficiency of power supply, the objective function F (P) indicating the cost of power supply represented by the equation (2) is required to be made small while observing the constraints expressed by the equations (3) and (4):

F(P)=Σᵢ₌₁^{N} (6ᵢP_{i,t}²+bᵢP_{i,t}+cᵢ) (2)

Pᵢ^{min}≤P_{i,t}≤Pᵢmax (3)

Σᵢ₌₁^{N} P_{i.t}=Dₜ (4)

Here, P_{i, t} indicates the output power of the ith generator in the power system 230 at a time t. In the following, the subscript indicating the time t will be omitted. Coefficients aᵢ, bᵢ, and cᵢ are constants that define the cost corresponding to the output power Pᵢ at the ith generator. The equation (3) indicates the constraint that defines the scope of each output power Pᵢ. The equation (4) indicates the constraint on the relationship between the output power Pᵢ and the demand power D. In the equation (3), Pᵢ^{min} indicates the minimum value of the output power Pᵢ, and Pᵢ^{max} indicates the maximum value of the output power Pᵢ.

Since the output power Pᵢ defined in each of the equations (2), (3), and (4) is a continuous value, the output power Pᵢ cannot be applied to the quantum computer using the Ising model in this state. Therefore, in Steps S602 and S603, the non-von Neumann calculation unit 103 discretizes the output power Pᵢ and performs mapping processing of allocating the spin to each solution in the discretized discrete solution space.

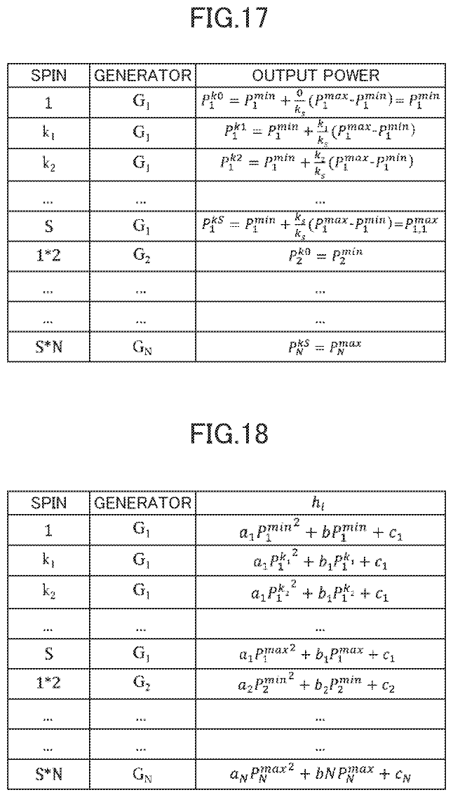

FIG. 17 is an example in which the output power P₁ to P_{N} of the N generators G₁ to G_{N} are discretized. In the example of FIG. 17, the output power P₁ to P_{N} of the generators G₁ to G_{N} that satisfy the equation (2) are respectively discretized into S+1 pieces of discrete values Pᵢ^{k0} to Pᵢ^{ks} to be mapped to separate spins. Incidentally, 0<kᵢ<k₂−<kₛ.

In Step S604, the non-von Neumann calculation unit 103 generates an external magnetic field hᵢ corresponding to each spin according to the value of each of the output power Pᵢ^{k0} to Pᵢ^{ks} mapped to each spin, and generates an objective function H_{obj} in the Ising model by using the external magnetic field hᵢ.

FIG. 18 is a diagram showing an external magnetic field hᵢ for each spin. The external magnetic field is discretized as shown in FIG. 18. Using the external magnetic field shown in FIG. 18, the objective function H_{obj} can be expressed by the following equation (5):

H_{obj}=Σᵢ₌₁^{S*N} hᵢ σᵢ (5)

In Step S605, the non-von Neumann calculation unit 103 sets a simultaneous determination constraint H_{constraint, l}. The simultaneous determination constraint H_{constraint, l} can be expressed by the following equation (6):

H_{constraint,l}=γ(1−Σᵢ₌ₗ^{S+l} σᵢ)l ∈ N (6)

Here, γ is a penalty term and has a large value as compared with a possible value of the objective function H_{obj}. In the simultaneous determination constraint H_{constraint, l}, when a plurality of spins out of N+1 spins corresponding to each generator become “1” at the same time, the value of the equation (6) becomes large due to the penalty term γ, so that the Hamiltonian H (σ) becomes a large value, and such a large value is excluded from the solution of the combination problem that determines the value of the spin 601 so that the Hamiltonian H (σ) becomes small.

In Step S606, the non-von Neumann calculation unit 103 sets a linear constraint. In the case of the present embodiment, it is necessary to satisfy the constraint on the relationship between the output power and the demand as shown in the equation (4). The linear constraint H_{constraint, PF1} corresponds to the constraint on the relationship between the output power and the demand. The linear constraint H_{constraint, PF1} can be expressed by the following equation (6):

H_{constraint,PF1}=γ(D−Σᵢ₌₁^{S*N} σᵢ)² (7)

γ is a penalty term and has a large value as compared with a possible value of the objective function H_{obj}. In the linear constraint H_{constraint, PF1}, when the sum of the output power of the respective generators deviates from the demand power, the value of the equation (7) becomes large due to the penalty term γ, so that the Hamiltonian H (σ) becomes a large value. Such a large value is excluded from the solution of the combination problem that determines the value of the spin 601 so that the Hamiltonian H (σ) becomes small.

In Step S607, the non-von Neumann calculation unit 103 constructs a Hamiltonian by adding together the equations (5), (6), and (7). After that, in Step S608, the non-von Neumann calculation unit 103 generates and outputs a non-von Neumann calculation result having solved the combination problem by using the Hamiltonian.

### Fifth Embodiment

In the present embodiment, as an application example of the first embodiment, description will be made about an example in which a power system operational support system calculates assessment criterion data. Hereinafter, the points of difference from the first embodiment will be mainly described. The features according to the present embodiment may be applied to the second to fourth embodiments.

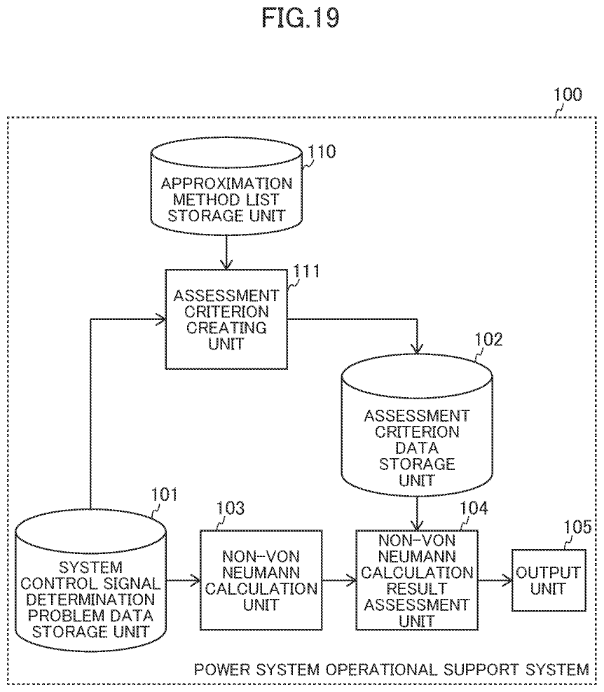

FIG. 19 is a diagram showing an example of a functional configuration of the power system operational support system according to the fifth embodiment. The power system operational support system 100 shown in FIG. 19 further includes an approximation method list storage unit 110 and an assessment criterion creating unit 111 in addition to the configuration of the power system operational support system 100 shown in FIG. 1.

The approximation method list storage unit 110 is a list storage unit which stores an approximation method list being a list showing a plurality of approximation methods for simplifying and solving the system control signal determination problem. The approximation method is, for example, a method of approximating a high-dimensional determination problem to a low-dimensional determination problem, etc.

The assessment criterion creating unit 111 selects any of a plurality of approximation methods from the approximation method list on the basis of the degree of urgency of the control signal determination problem indicated by the problem data and generates an approximation calculation result in which the control signal determination problem is solved by using the selected approximation method. The assessment criterion creating unit 111 generates assessment criterion data, based on the approximation calculation result and stores it in the assessment criterion data storage unit 102. Further, the assessment criterion creating unit 111 may select the approximation method on the basis of hardware constraint information regarding the calculation speed of hardware that solves the control signal determination problem by using the approximation method in addition to the degree of urgency. In the present embodiment, the hardware that solves the control signal determination problem using the approximation method is the power system operational support system 100 (more specifically, the von Neumann computer 210).

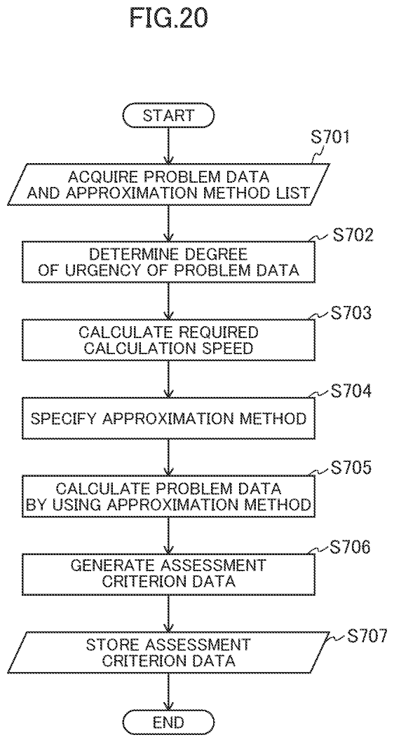

FIG. 20 is a flowchart for describing an example of the operation of the assessment criterion creating unit 111.

First, the assessment criterion creating unit 111 acquires the problem data from the problem data storage unit 101 and acquires the approximation method list from the approximation method list storage unit 110 (Step S701). The assessment criterion creating unit 111 determines the degree of urgency of the problem data (Step S702). For example, the assessment criterion creating unit 111 increases the degree of urgency as the time interval for switching the control signal included in the problem data is shorter.

The assessment criterion creating unit 111 calculates the required calculation speed of the calculation to solve the control signal determination problem indicated by the problem data, based on the determined degree of urgency and the hardware constraint information of the power system operational support system 100 (Step S703). For example, the assessment criterion creating unit 111 obtains a processing lower limit value which is a lower limit value of the processing time for the calculation to solve the control signal determination problem according to the degree of urgency, and calculates as required calculation efficiency, a calculation speed at which the processing time of the calculation to solve the control signal determination problem becomes a lower limit value of processing or more, based on the hardware information.

The assessment criterion creating unit 111 selects an approximation method corresponding to the calculated required calculation speed from the approximation method list (Step S704). For example, the required calculation speed is associated with each approximation method in advance in the approximation method list, and the assessment criterion creating unit 111 selects the approximation method corresponding to the required calculation speed closest to the calculated required calculation speed.

The assessment criterion creating unit 111 calculates an approximation calculation result obtained by using the selected approximation method to solve the system control signal determination problem indicated by the problem data (Step S705). The assessment criterion creating unit 111 generates assessment criterion data, based on the approximation calculation result (Step S706). For example, the assessment criterion creating unit 111 generates assessment criterion data, based on an allowable error range (effective range) of the approximation method. The assessment criterion creating unit 111 stores the assessment criterion data in the assessment criterion data storage unit 102 (Step S707).

As described above, the present disclosure includes the following matters.

The power system operational support system (100) according to one aspect of the present disclosure includes a problem storage unit (101), a non-von Neumann calculation unit (103), a criterion storage unit (102), and an assessment unit (104). The problem storage unit (101) stores problem data indicating a determination problem for determining a plurality of control signals used for control of a controlled device (233) included in a power system (230). The non-von Neumann calculation unit generates a non-von Neumann calculation result in which the determination problem is solved by using a non-von Neumann computer, based on the problem data. The criterion storage unit stores assessment criterion data for assessing the non-von Neumann calculation result. The assessment unit assesses an assessment item related to the non-von Neumann calculation result, based on the assessment criterion data.

With the above configuration, the determination problem of determining a plurality of control signals used for control of the controlled device included in the power system is solved by using the non-von Neumann computer, and the assessment item related to the non-von Neumann calculation result is assessed. Thus, since it is possible to solve the determination problem by the non-von Neumann computer and further assess the non-von Neumann calculation result, the power system can be controlled appropriately even if the amount of calculation increases.

Also, the power system operational support system further has an output unit which outputs an assessment result by the assessment unit. Thus, since it is possible to allow the user of the power system operational support system or the like to confirm the assessment result, the power system can be controlled more appropriately.

Further, the assessment item includes at least one of a control value being the value of each control signal indicated by the non-von Neumann calculation result, an interrelation value indicating the interrelationship of each control signal, and a calculation time required to solve the determination problem by the non-von Neumann computer. Thus, since it is possible to assess an appropriate assessment item, the power system can be controlled more appropriately.

In addition, the non-von Neumann calculation unit has a non-von Neumann computer (208), and a conversion unit (207) which converts the problem data into a format corresponding to the non-von Neumann computer and inputs it to the non-von Neumann computer, and acquires a non-von Neumann calculation result from the non-von Neumann computer. Thus, since it is possible to allow the non-von Neumann computer to solve the determination problem appropriately, the power system can be controlled more appropriately.

Also, the power system operational support system further has a feedback unit (107) which adjusts parameters of calculation processing for solving the determination problem by the non-von Neumann computer, based on the assessment result by the assessment unit. Thus, since it is possible to improve the accuracy of the non-von Neumann calculation result, the power system can be controlled more appropriately.

In addition, the power system operational support system further has a control unit (109) which controls the controlled device using the non-von Neumann calculation result when the assessment result by the assessment unit satisfies a predetermined condition. Thus, since it is possible to control the controlled device by using the non-von Neumann calculation result when the assessment result is good, the power system can be controlled more appropriately.

Further, the power system operational support system has a von Neumann calculation result storage unit which stores a von Neumann calculation result obtained by using a von Neumann computer to solve the determination problem, and controls the controlled device by using either the non-von Neumann calculation result or the von Neumann calculation result, based on the assessment result by the assessment unit. Thus, since the von Neumann calculation result can be used as a backup even when the assessment result is not good, it is possible to prevent the power system from being not properly controlled.

Besides, the non-von Neumann computer is a quantum computer using an Ising model. Thus, even if the amount of calculation increases, the determination problem can be solved in a short time.

Also, the non-von Neumann calculation unit solves the determination problem by using a Hamiltonian constructed by adding together an objective function in which each solution in the discrete solution space in which the solution space of the determination problem is discretized is assigned to the spin, a first constraint condition for determining a single solution for each control signal, and a second constraint condition related to the interrelation of each control signal. Thus, since it is possible to solve the determination problem by using the appropriate Hamiltonian, the power system can be controlled more appropriately.

In addition, the power system operational support system further has a list storage unit which stores a list indicating a plurality of approximation methods that simplify and solve the determination problem, and a criterion creating unit which selects any of the plural approximation methods, based on the degree of urgency of the determination problem, solves the determination problem by using the selected approximation method to generate an approximation calculation result, and creates the assessment criterion data, based on the approximation calculation result. Therefore, even when an emergency situation or the like occurs and the user does not have time to create appropriate assessment criterion data, it is possible to create appropriate assessment criterion data, so that the power system can be controlled more appropriately.

Furthermore, the criterion creating unit selects the approximation method, based on the hardware constraint information on the calculation speed of the hardware that solves the determination problem by using the approximation method, and the degree of urgency. Since it becomes possible to select a more appropriate approximation method, the power system can be controlled more appropriately.

The above-described embodiments of the present disclosure are examples for describing the present disclosure, and the scope of the present disclosure is not intended to be limited only to those embodiments. A person skilled in the art can practice the present invention in various other aspects without departing from the scope of the present invention.

### LIST OF REFERENCE SIGNS

100: power system operational support system, 101: system control signal determination problem data storage unit (problem data storage unit), 102: assessment criterion data storage unit, 103: non-von Neumann calculation unit, 104: non-von Neumann calculation result assessment unit, 105: output unit, 106: non-von Neumann computer setting adjustment data storage unit (adjustment data storage unit), 107: assessment result feedback unit, 108: von Neumann calculation result storage unit, 109: control unit, 110: approximate method list storage unit, 111: assessment criterion creating unit, 201: CPU, 202: storage device, 203: GPU, 204: input device, 205: output device, 206: communication device, 207: non-von Neumann computer adapter, 208: non-von Neumann computer, 209: data bus, 210: von Neumann computer, 220: communication network, 230: power system, 231: measuring instrument, 232: control terminal, 600: Ising model, 601: spin, 602: external magnetic field 602, 603: mutual magnetic field.

1-12. (canceled)

13. A power system operational support system comprising:
a problem storage unit which stores problem data indicating a determination problem determining a plurality of control signals to be used to control a device to be controlled included in a power system;
a non-von Neumann calculation unit which generates a non-von Neumann calculation result obtained by using a non-von Neumann computer to solve the determination problem on the basis of the problem data;
a criterion storage unit which stores assessment criterion data for assessing the non-von Neumann calculation result; and
an assessment unit which assesses an assessment item related to the non-von Neumann calculation result on the basis of the assessment criterion data,
wherein the non-von Neumann computer is a quantum computer using an Ising model, and
wherein the assessment item includes at least one of a control value being a value of each control signal indicated by the non-von Neumann calculation result, an interrelation value indicating an interrelationship of each control signal, and a calculation time required to solve the determination problem by the non-von Neumann computer.

14. The power system operational support system according to claim 13, further including an output unit which outputs an assessment result by the assessment unit.

15. The power system operational support system according to claim 13, wherein the non-von Neumann calculation unit includes:
the non-von Neumann computer, and
a conversion unit which converts the problem data into a format corresponding to the non-von Neumann computer and inputs the same to the non-von Neumann computer, and acquires the non-von Neumann calculation result from the non-von Neumann computer.

16. The power system operational support system according to claim 13, further including a feedback unit which adjusts parameters of calculation processing for solving the determination problem by the non-von Neumann computer on the basis of the assessment result by the assessment unit.

17. The power system operational support system according to claim 13, further including a control unit which controls the controlled device using the non-von Neumann calculation result when the assessment result by the assessment unit satisfies a predetermined condition.

18. The power system operational support system according to claim 13, including:
a von Neumann calculation result storage unit which stores a von Neumann calculation result obtained by using a von Neumann computer to solve the determination problem, and
a control unit which controls the controlled device by using either the non-von Neumann calculation result or the von Neumann calculation result on the basis of the assessment result by the assessment unit.

19. The power system operational support system according to claim 13, wherein the non-von Neumann calculation unit solves the determination problem by using a Hamiltonian constructed by adding together an objective function in which each solution in a discrete solution space in which a solution space of the determination problem is discretized is assigned to a spin, a first constraint condition for determining a single solution for each control signal, and a second constraint condition related to the interrelation of each control signal.

20. The power system operational support system according to claim 13, further including:
a list storage unit which stores a list indicating a plurality of approximation methods which simplify and solve the determination problem, and
a criterion creating unit which selects any of the plural approximation methods on the basis of the degree of urgency of the determination problem, solves the determination problem by using the selected approximation method to generate an approximation calculation result, and creates the assessment criterion data on the basis of the approximation calculation result.

21. The power system operational support system according to claim 20, wherein the criterion creating unit selects the approximation method on the basis of hardware constraint information on a calculation speed of hardware which solves the determination problem by using the approximation method, and the degree of urgency.

22. A power system operational support method executed by a power system operational support system, the method comprising:
generating, based on problem data indicating a determination problem for determining a plurality of control signals used for control of a controlled device included in a power system, a non-von Neumann calculation result in which the determination problem is solved by using a non-von Neumann computer; and
assessing an assessment item related to the non-von Neumann calculation result on the basis of assessment criterion data for assessing the non-von Neumann calculation result,
wherein the non-von Neumann computer is a quantum computer using an Ising model, and
wherein the assessment item includes at least one of a control value being a value of each control signal indicated by the non-von Neumann calculation result, an interrelation value indicating an interrelationship of each control signal, and a calculation time required to solve the determination problem by the non-von Neumann computer.
